(19) United States
(12) Patent Application Publication
(10) Pub. No.: US 2026/0298006 A1
(43) Pub. Date: Oct. 1, 2026

(54) VEHICLE DOOR ACTUATION MECHANISM AND ASSOCIATED VEHICLE

(71) Applicant: Minebea AccessSolutions France, Alfortville (FR)

(72) Inventors: Benoit FRANKE, Alfortville (FR); Robin DUVAUCHELLE, Alfortville (FR); François DEBROUCKE, Alfortville (FR)

(73) Assignee: Minebea AccessSolutions France, Alfortville (FR)

(21) Appl. No.: 19/572,161

(22) Filed: Mar. 19, 2026

(30) Foreign Application Priority Data
Mar. 25, 2025 (EP) 25315097

(51) Int. Cl. E05F 15/616

(52) U.S. Cl. CPC E05F 15/616; E05Y 2201/716; E05Y 2201/722; E05Y 2900/531

(57) ABSTRACT

A vehicle door actuation mechanism for a vehicle door includes an electrical motor and a gearing mechanism for releasing the vehicle door upon activation of the electrical motor. The gearing mechanism includes a multiple gear wheel with at least two coaxial gearings shifted angularly

### TECHNICAL FIELD

The present invention relates to a vehicle door actuation mechanism, the door may be a side door or a trunk lid.

### BACKGROUND OF THE INVENTION

In order to increase the comfort of the passengers and to ease the opening of the doors of vehicles, recent vehicles are equipped with door actuation mechanisms configured to open automatically a door upon a predetermined command of a user such as a push on a control button or a move in front of a detector.

Such door actuation mechanisms generally comprise an electric motor generating a torque and a mechanism to convert the output torque into a force to move the load, i.e. the door.

Such mechanisms need to be powerful enough to ensure a correct functioning in all conditions and notably with cold temperature and frozen door seals and with a lifetime corresponding to the lifetime of the vehicle.

In order to obtain such powerful actuation mechanisms, it is known to use an oversized motor but such solution tends to increase the bulk, the weight, the power consumption and the cost of the actuation mechanism.

It is therefore a goal of the present invention to provide a door actuation mechanism capable of transmitting a higher torque while limiting the increase of bulk, weight, power consumption and cost.

### SUMMARY OF THE INVENTION

To achieve this goal, the present invention refers to a vehicle door actuation mechanism comprising:
an electrical motor,
a gearing mechanism configured for releasing the vehicle door upon activation of the electrical motor,
wherein the gearing mechanism comprises a multiple gear wheel with at least two coaxial gearings of same size that are shifted angularly of a predetermined angle. Both coaxial gearings may be identical. Both coaxial gearings may have the same diameter and the same number of teeth. Both coaxial gearings are secured to each other so that the angular shift is constant. Both coaxial gearings are configured to mesh simultaneously with teeth or cogs of another complementary element such as a multiple gear wheel or a multiple rack. Both coaxial gearings act therefore in parallel so that the mechanical constraints of each gearing are reduced. The multiple gear wheel may be a monobloc element. The gearing mechanism may be used to displace a piston of the vehicle door actuation mechanism configured to open a door of a vehicle.

The use of a gearing mechanism with a multiple gear wheel with two gearings acting simultaneously in parallel on the same complementary element allows the transmission of a high torque or the transformation of a high torque into a high force with a reduced bulk and therefore to provide a compact actuation mechanism.

According to another embodiment of the present invention, the vehicle door actuation mechanism comprises an additional multiple gear wheel complementary with the multiple gear wheel, both multiple gear wheels being configured to mesh with each other. The gearings of the additional multiple gear wheel may be identical (same diameter and same number of teeth (and therefore teeth of the same size)) but may be different than the gearings of the complementary multiple gear wheel. Both series of teeth remain stationary with each other. The multiple gear wheel may be a monobloc element. The coaxial gearings are configured to mesh simultaneously with the teeth of the additional multiple gear wheel.

According to another embodiment of the present invention, the vehicle door actuation mechanism comprises a multiple rack complementary with the multiple gear wheel. The multiple rack may comprise at least two parallel series of cogs which are linearly offset and configured to mesh with teeth of the multiple gear wheel. Both series of cogs may lay next to each other. The series of cogs of the multiple rack may be identical (cogs of the same size). Both series of cogs remain stationary with each other. The multiple rack may be a monobloc element. The coaxial gearings are configured to mesh simultaneously with the respective series of cogs of the multiple rack.

According to another embodiment of the present invention, the vehicle door actuation mechanism comprises a housing and a piston, the multiple rack is arranged on the piston and the piston is configured to be displaced from a retracted position within the housing to a deployed position protruding outside of the housing to release the vehicle door.

According to another embodiment of the present invention, the vehicle door actuation mechanism also comprises a mechanical reductor and wherein the mechanical reductor comprises an output shaft coupled in rotation with the multiple gear wheel.

According to another embodiment of the present invention, the electrical motor comprises an output shaft with a worm configured to mesh with a gear wheel of the mechanical reductor.

According to another embodiment of the present invention, the multiple gear wheel comprises a number of coaxial gearings higher than two, two adjacent coaxial gearings having the same size and being shifted angularly of a predetermined angle.

According to another embodiment of the present invention, the coaxial gearings are shifted angularly with respect to each other with a pitch depending on the number of coaxial gearings.

According to another embodiment of the present invention, the vehicle door mechanism is configured to be arranged on a vehicle door.

According to another embodiment of the present invention, the vehicle door mechanism is configured to be arranged on a pillar of the vehicle body located next to the vehicle door.

The present invention also refers to a vehicle comprising a vehicle door actuation mechanism as described previously.

The invention will be better understood in view of the following description, referring to the annexed figures in which:

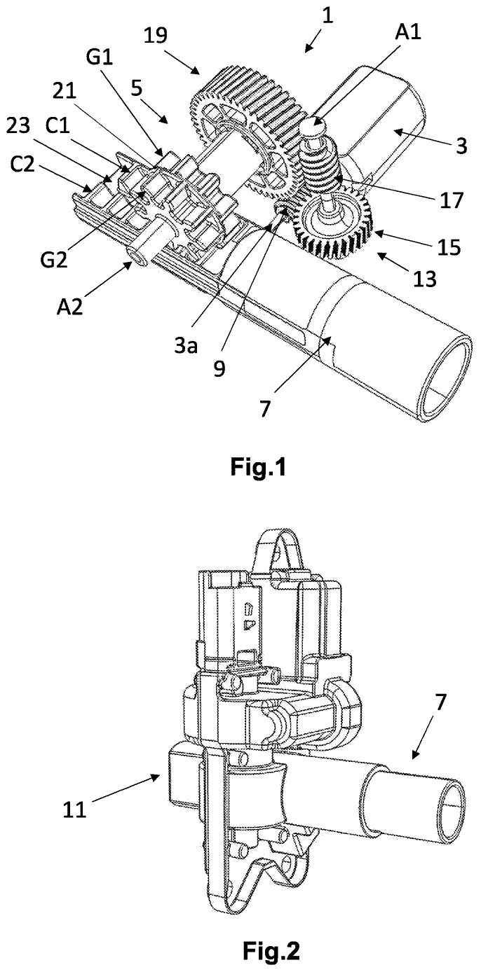

FIG. 1 is a perspective view of some element of a vehicle door actuation mechanism according to an embodiment of the present invention;

FIG. 2 is another perspective view of a vehicle door actuation mechanism according to an embodiment of the present invention;

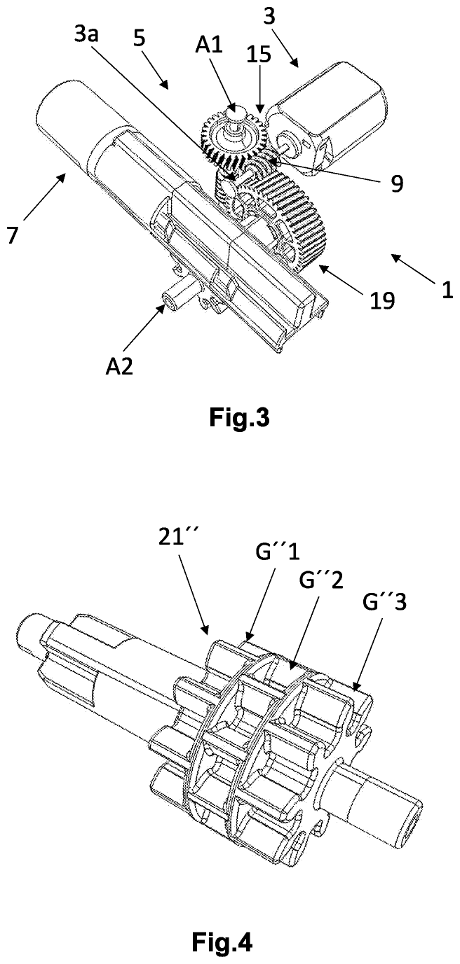

FIG. 3 is another perspective view of the elements of FIG. 1;

FIG. 4 is a perspective view of a multiple gear wheel according to a further embodiment of the prevent invention;

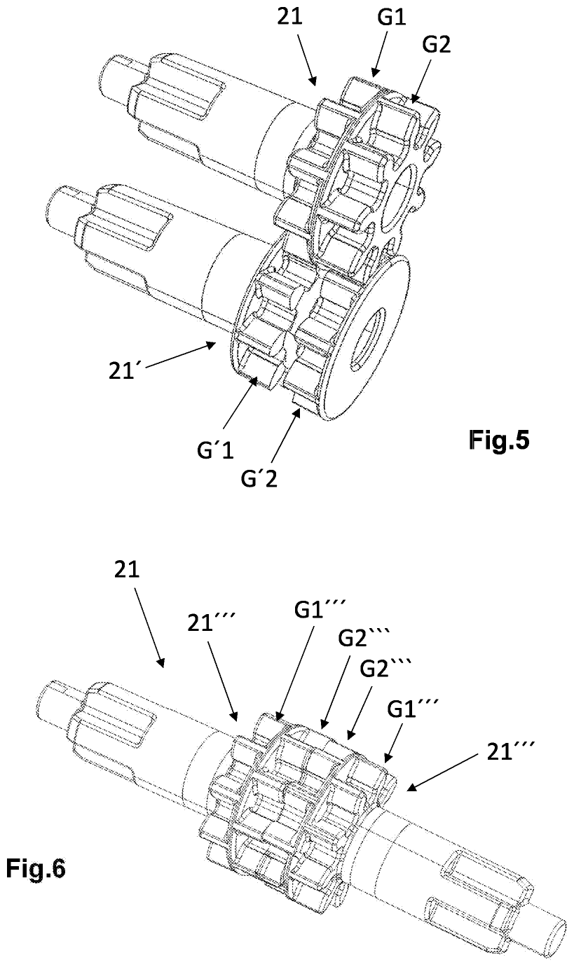

FIG. 5 is a perspective view of two multiple gear wheels meshing with each other;

FIG. 6 is a perspective view of a further embodiment of a multiple gear wheel;

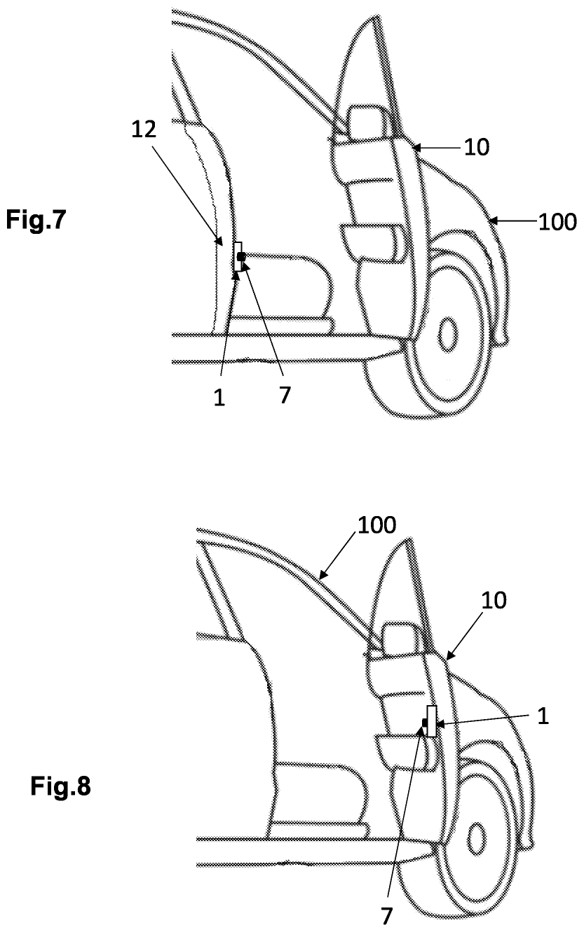

FIG. 7 is a perspective view of a portion of a vehicle with a vehicle door actuation mechanism arranged on vehicle body;

FIG. 8 is a perspective view of a portion of a vehicle with a vehicle door actuation mechanism arranged on a door;

In these figures, identical or similar elements bear the same reference numerals. Only the elements necessary for understanding the invention are shown.

### DETAILED DESCRIPTION OF THE INVENTION

The following achievements are examples. Although the specification refers to one or several embodiments, it does not imply that each reference refers to the same embodiment or that the features apply only to a single embodiment. Simple features of different embodiments can also be combined to provide other embodiments without departing form the scope of the invention defined by the claims.

By gearings of the same size, it is intended to specify two gearings having the same external diameter and the same number of teeth if the teeth are distributed all around the gearing.

The present invention refers to a vehicle door actuation mechanism 1 configured to open a door 10 automatically, for example upon reception of an opening signal initiated by a user by pushing on a command button or upon detection by a sensor of an opening command.

FIG. 1 represents a vehicle door actuation mechanism 1 according to an embodiment of the present invention. The vehicle door actuation mechanism 1 comprises an electrical motor 3 and a gearing mechanism 5 and a piston 7 configured to be displaced axially by the electrical motor 3 between a retracted position wherein the door 10 can be closed and a deployed position wherein the vehicle door 10 is released. The electrical motor 3 and the gearing mechanism 5 may be surrounded by a housing 11 (visible in FIG. 2) and the piston 7 may be configured to protrude out of the housing 11 in the deployed position.

The gearing mechanism 5 may also comprise a first worm 9 (better visible in FIG. 3) arranged on the output shaft 3a of the electrical motor 3 and coupled in rotation with the said output shaft 3a.

The gearing mechanism 5 may also comprise a mechanical reductor 13 arranged between the electrical motor 3 and the piston 7.

According to the embodiment represented in FIG. 1, the mechanical reductor 13 comprises a first gear wheel 15 arranged on a first shaft A1 and coupled in rotation with the said first shaft A1. The first shaft A1 may extend perpendicular to the output shaft 3a of the electrical motor 3. The first gear wheel 15 is configured to mesh with the first worm 9. The first gear wheel 15 has a first diameter D1. A second worm 17 is arranged on the first shaft A1 and is coupled in rotation with the first shaft A1.

The mechanical reductor 13 also comprises a second gear wheel 19 arranged on a second shaft A2 and coupled in rotation with the said second shaft A2. The second shaft A2 may extend parallel to the output shaft 3a. The second gear wheel 19 is configured to mesh with the second worm 17. The second gear wheel has a second diameter D2, different than the diameter D1 of the first gear wheel 15. The second diameter D2 is for example larger than the first diameter D1.

According to other embodiments, the mechanical reductor 13 may comprise other gearings such as other worms or gear wheels or more complex mechanisms such as a gearbox or a planetary gear.

The gearing mechanism 5 also comprises a multiple gear wheel 21. The multiple gear wheel 21 comprises at least two coaxial gearings G1, G2 of the same size, for example with the diameter and the same number of teeth, that are shifted angularly with respect to each other of a predetermined angle. Both coaxial gearing are secured to each other and cannot move angularly with respect to each other. In the example of FIG. 1, the multiple gear wheel 21 comprises a first and a second coaxial gearings noted G1 and G2 that are shifted of half the pitch (the pitch refers to the angle between two adjacent teeth of a pinion). With a higher number of coaxial gearings, the angular shift between the adjacent gearings may be equal to the pitch divided by n with n the number of adjacent gearings. FIG. 4 represents an example of an embodiment of multiple gearing 21″ with three coaxial gearing noted G″1, G″2 and G″ that are shifted of a third of a pitch. Such angular shift equal to the pitch divided by the number of coaxial gearings provides a multiple gear wheel 21, 21″ which maximizes the contact surface between the teeth of the multiple gear wheel 21, 21″ and the associated multiple part such as another multiple gear wheel 21, 21″ (as represented in FIG. 5) or a multiple rack 23 (as represented in FIG. 1) as described in the following of the description. Such configuration enables maximizing the transmitted torque by limiting the constraints on each gearing.

In the example of FIG. 1, the gearing mechanism 5 also comprises a multiple rack 23 complementary with the multiple gear wheel 21. In the example of FIG. 1, the multiple rack 23 is arranged on the piston 7. The multiple rack 23 comprises a first and a second series of cogs noted C1 and C2 that extends parallel to each other. The first C1 and the second C2 series of cogs also extends next to each other. Both series of cogs are secured to each other and cannot move linearly with respect to each other. The multiple rack 23 may be a monobloc element. The first C1 and the second C2 series of cogs are linearly offset of a predetermined pitch and are configured to mesh respectively with teeth of the first G1 and the second G2 coaxial gearings of the multiple gear wheel 21. The first gearing G1 is configured to mesh with the first series of cogs C1 while the second gearing G2 is configured to mesh with the second series of cogs C1. Both series of cogs may be identical, same size for the cogs and same pitch between the cogs to ensure the complementarity with the gearings of same size. The offset is therefore equal to half the pitch (the pitch being equal to the distance between two consecutive cogs of a series of cogs). With a gear wheel with a number of coaxial gearing higher than two, the multiple rack 23 would have a higher number of series of cogs with an offset equal to the pitch divided by the number of series of cogs. For example, with the multiple gear wheel 21″ of FIG. 4, a complementary rack would have three series of cogs offset by a third of a pitch.

In operation, the gearings G1, G2 of the multiple gear wheel 21 mesh respectively with the series of cogs C1, C2 of the multiple rack 23 so that the torque is transmitted by both gearings G1, G2 acting in parallel which results in a reduction of the mechanical constraints on the teeth of the gearings G1, G2 and the cogs C1, C2 of the multiple rack 23 so that a higher torque and a higher force may be transmitted by the gearing mechanism 5 without increasing the size of the gearings G1, G2 or of the cogs C1, C2.

If we consider the embodiment of FIGS. 1 and 3 the electrical motor 3 drives the rotation of the first worm 9 which drives the rotation of the first gear wheel 15 and of the second worm 17 which is coupled in rotation with the first gear wheel 15. The second worm 17 drives the rotation of the second gear wheel 19 and of the multiple gear wheel 21 which is coupled in rotation with the second gear wheel 19. Both gearings G1 and G2 of the multiple gear wheel 21 mesh respectively with the series of cogs of the multiple rack 23 of the piston 7 and drives therefore the translation of the piston 7. As both gearings G1 and G2 are identical, half of the transmitted torque is transmitted by each gear wheel G1 and G2 so that the mechanical constraints on each gearings are reduced. As a consequence, a higher torque may be transmitted without increasing the size (diameter and number of teeth) of the gearings.

Thus, the combination of the multiple gear wheel 21 and the multiple rack 23 allows transforming a high torque provided by the electrical motor 3 and the mechanical reductor 5 into a high force applied via the piston 7 to release the door 10. Due to the use of the multiple gear wheel and the multiple rack, the actuation mechanism may remain compact.

According to another embodiment represented in FIG. 5, the multiple gear wheel 21 is configured to mesh with another multiple gear wheel 21′. The first multiple gear wheel 21 and the second multiple gear wheel 21′ may be identical. Alternatively, the gearings of the second multiple gear wheel 21′ may have a different size (different diameter and different number of teeth) than the gearings of the first multiple gear wheel 21 (but the size of the gearings of the first multiple gear wheel or the second multiple gear wheel remain identical). The first gearing G1 of the first multiple gear wheel 21 is configured to mesh with the first gearing G′1 of the second multiple gear wheel 21′ and the second gearing G2 of the first multiple gear wheel 21 is configured to mesh with the second gearing G′2 of the second multiple gear wheel 21′.

In operation, the first gearing G1 of the first multiple gear wheel 21 mesh with the first gearing G′1 of the second multiple gear wheel 21′ and, at the same time, the second gearing G2 of the first multiple gear wheel 21 mesh with the second gearing G′2 of the second multiple gear wheel 21′. The torque is transmitted by both gearings G1/G2 and G′1/G′2 acting in parallel which results in a reduction of the mechanical constraints on the teeth of the gearings so that a higher torque may be transmitted by the actuation mechanism without increasing the size of the gearings.

Such configuration enables transmitting a high torque without increasing the size of the parts and allows therefore to provide a compact actuation mechanism 1.

According to a further embodiment, as represented in FIG. 6, the multiple gear wheel 21 may correspond to an assembly of two identical multiple gear wheels 21′″ that are positioned next to each other. Both identical multiple gear wheel 21′″ may be welded together. The adjacent gearings G2′″ of both gear wheels 21′″ may be positioned without angular shift as represented in FIG. 6. Alternatively, an angular shift may be arranged between the adjacent gearings G2′″ of both multiple gear wheels 21′″.

Thus, the actuation mechanism 1 according to the invention comprises at least one multiple gear wheel 21, 21′, 21″ which can be associated with one or several other multiple gear wheels 21, 21′, 21″ and/or one or several multiple rack 23 to provide a compact actuation mechanism 1 capable of transmitting a high torque or a high force to release a door 10.

According to an embodiment represented in FIG. 7, the vehicle door actuation mechanism 1 as described previously may be arranged on a vehicle body, for example on a pillar 12 located next to a door 10, for example next to a door latch. The piston 7 is then configured to push on the door frame when displaced in the deployed position by the electrical motor 5 to open the door 10. Preferably, the actuation mechanism 1 is arranged next to the door side which is opposite to the door hinges.

According to an alternative embodiment represented in FIG. 8, the vehicle door actuation mechanism 1 may be arranged on the door 10. The piston 7 is then configured to push on the vehicle body when displaced in the deployed position by the electrical motor 5 to open the door 10. Preferably, the actuation mechanism 1 is arranged on the door side which is opposite to the door hinges.

The present invention also refers to a vehicle 100 comprising a door actuation mechanism 1 as described previously.

1-11. (canceled)

12. A vehicle door actuation mechanism, comprising:
an electrical motor; and
a gearing mechanism configured to release a vehicle door upon activation of the electrical motor,
wherein the gearing mechanism comprises a multiple gear wheel with at least two coaxial gearings of a same size that are shifted angularly by a predetermined angle.

13. The vehicle door actuation mechanism according to claim 12, further comprising an additional multiple gear wheel complementary with the multiple gear wheel, both multiple gear wheels being configured to mesh with each other.

14. The vehicle door actuation mechanism according to claim 12, further comprising a multiple rack complementary with the multiple gear wheel, the multiple rack comprising at least two parallel series of cogs which are linearly offset by a predetermined pitch and configured to mesh respectively with teeth of the gearings of the multiple gear wheel.

15. The vehicle door actuation mechanism according to claim 14, further comprising a housing and a piston,
wherein the multiple rack is arranged on the piston, and
wherein the piston is configured to be displaced from a retracted position within the housing to a deployed position protruding outside of the housing to release a vehicle door.

16. The vehicle door actuation mechanism according to claim 12, further comprising a mechanical reductor,
wherein the mechanical reductor comprises an output shaft coupled in rotation with the multiple gear wheel.

17. The vehicle door actuation mechanism according to claim 16, wherein the electrical motor comprises an output shaft with a worm configured to mesh with a gear wheel of the mechanical reductor.

18. The vehicle door actuation mechanism according to claim 12, wherein the multiple gear wheel comprises a number of the coaxial gearings higher than two, and two of the coaxial gearings are adjacent and shifted angularly by a predetermined angle.

19. The vehicle door actuation mechanism according to claim 18, wherein the coaxial gearings are shifted angularly with respect to each other with a pitch depending on the number of the coaxial gearings.

20. The vehicle door actuation mechanism according to claim 12, wherein the vehicle door mechanism is configured to be arranged on the vehicle door.

21. The vehicle door actuation mechanism according to claim 12, wherein the vehicle door mechanism is configured to be arranged on a pillar of a vehicle body located next to the vehicle door.

22. A vehicle, comprising:
the vehicle door actuation mechanism according to claim 12.
